(19) United States
(12) Patent Application Publication
(10) Pub. No.: US 2026/0071821 A1
(43) Pub. Date: Mar. 12, 2026

(54) DEVICE FOR INCREASING PRODUCTIVITY

(71) Applicant: Siemens Medical Solutions USA, Inc., Malvern, PA (US)

(72) Inventors: Mark Andreaco, Knoxville, TN (US); Troy Marlar, Knoxville, TN (US); Peter Cohen, Rockford, TN (US)

(21) Appl. No.: 18/826,453

(22) Filed: Sep. 6, 2024

(51) Int. Cl. F27B 14/10; F27B 14/06; F27D 99/00

(52) U.S. Cl. CPC F27B 14/10; F27B 2014/066; F27D 2099/0083

(57) ABSTRACT

Disclosed herein is a furnace for producing single crystal boules, the furnace comprising a furnace wall; a plurality of crucibles, where each crucible is operative to contain a melt that is contacted by a different pull rod; where each pull rod is attached to seed crystal; a first drive system that is located above the furnace and is configured to drive a first main shaft that is either in a geared or belted communication with a plurality of first planetary shafts; where each pull rod is in rotary communication at least one planetary shaft; where each pull rod is operative to contact the melt while undergoing rotary and translational motion with respect to a melt in one of the plurality of crucibles; where each crucible is surrounded by an induction coil and a refractory lining; and wherein each induction coil and refractory lining lie within the furnace wall.

### BACKGROUND

This disclosure relates to a device for increasing manufacturing productivity of crystalline boules. More specifically, this disclosure relates to a device for increasing the manufacturing productivity of crystalline boules of a scintillating material.

A crystal boule refers to a cylindrical crystal ingot that is used as a material in the production of semiconductor wafers or of scintillators that are used in medical imaging modalities such as positron emission tomography (PET), single photon emission computed tomography (SPECT), computed tomography (CT), mammography and many of x-ray imaging devices. These boules used in in the production of semiconductor wafers are often made of materials such as silicon, germanium or other semiconductor materials. These boules used in the production of scintillators for medical diagnostic imaging very often include lutetium oxy-orthosilicates (LSO's), lutetium yttrium oxy-orthosilicates (LYSO's), gadolinium oxy-orthosilicates (GSO's), gadolinium aluminum gallium garnets (GAGG's), gadolinium-gallium-aluminum garnet (GGAG's), gadolinium-yttrium-gallium-aluminum garnet (GYGAG's), gadolinium-lutetium-gallium-aluminum garnet (GLuGAG's), gadolinium-scandium-gallium garnet (GSGG's), gadolinium-yttrium-aluminum garnet (GYAG's), gadolinium-scandium-aluminum garnet (GSAG's), gadolinium-gallium garnet (GGG's) or gadolinium-yttrium-scandium-aluminum garnet (GYSAG's).

The process of manufacturing a crystalline boule comprises melting the raw materials in powder form in a crucible, drawing the melt from the crucible to form a crystalline material and then slowly cooling it down to room temperature. The resulting crystal boule is then sliced into thin wafers, which serve as the basis for manufacturing electronic components such as integrated circuits or to make crystalline sub-elements used for radiation detection media in medical imaging applications.

The production of a crystalline boule having a radius of 5 to 75 centimeters is typically a slow process that takes from a few hours to many days depending on the material produced and method of process of making. It is desirable to increase the rate of production of crystalline boules. This may be accomplished by increasing the size of a boule during the manufacturing process. However, this allows only one boule to be manufactured at one time in one furnace. There therefore remains a desire to increase the rate of production of crystalline boules within a furnace.

### SUMMARY

Disclosed herein is a furnace for producing a plurality of single crystal boules, the furnace comprising a furnace wall; a plurality of crucibles, where each crucible is operative to contain a melt that is contacted by a different pull rod; where each pull rod is attached to seed a crystal; a first drive system that is located above the furnace and is configured to drive a first main shaft that is either in a geared or belted communication with a plurality of first planetary shafts; where each pull rod is in rotary communication at least one planetary shaft; where each pull rod is operative to simultaneously contact the melt in one of the plurality of crucibles while undergoing rotary and translational motion with respect to the melt in a respective crucible; where each crucible is surrounded by an induction coil and a refractory lining; and wherein each induction coil and refractory lining lie within the furnace wall.

Disclosed herein too is a method for simultaneously producing a plurality of crystalline boules, the method comprising disposing raw materials in each crucible of a plurality of crucibles, where each crucible is located within a furnace wall of a furnace; heating the raw materials to a melt point; simultaneously contacting each melt in each crucible with a pull rod; where each pull rod is in rotary and translational communication with a first drive system that is located above the furnace; where the first drive system is configured to drive a first main shaft that is either in a geared or belted communication with a plurality of first planetary shafts; where each pull rod is in rotary communication at least one planetary shaft; where each pull rod is operative to contact the melt while undergoing rotary and translational motion with respect to a melt in each one of the plurality of crucibles.

### BRIEF DESCRIPTION OF THE FIGURES

FIG. 1 is a depiction of an exemplary apparatus used to simultaneously manufacture multiple crystal boules; and

FIG. 2 is another depiction of the exemplary apparatus of the FIG. 1, which can be used to simultaneously manufacture multiple crystal boules.

### DETAILED DESCRIPTION

Disclosed herein is an apparatus for the simultaneous manufacture of a plurality of crystalline boules in a single furnace. Each apparatus can be used to simultaneously manufacture 2 to 10 crystalline boules. The apparatus comprises a furnace in which are disposed a plurality of crucibles. Each crucible contains molten ingredients that can be used to manufacture the crystalline boule. The molten ingredients in each crucible are contacted with a seed crystal located at one end of a pull rod. Each pull rod is in contact with a first drive that permits it to be slowly moved away from the melt (moved vertically) while undergoing rotary motion. The vertical and rotary motion (translational motion) of the pull rod is used to produce a crystal boule. In an embodiment, each crucible is in contact with an optional second drive that permits each crucible to rotate in an opposite direction to that of the pull rod.

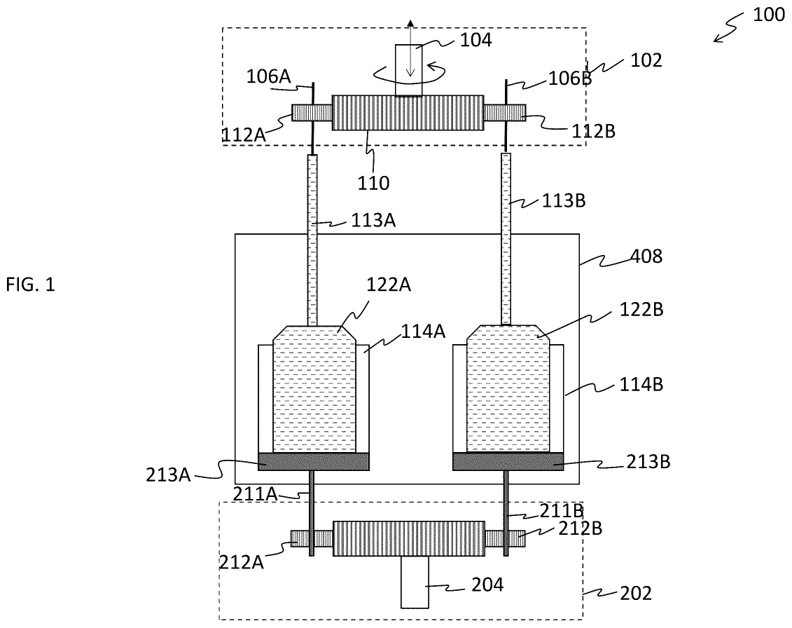

FIG. 1 is a depiction of an exemplary apparatus 100 used to simultaneously manufacture multiple crystal boules. The apparatus comprises a furnace 408 in which are disposed a plurality of crucibles 114A, 114B, . . . , and so on, that may be used to simultaneously produce a plurality of crystalline boules 122A, 122B, . . . , and so on. The apparatus comprises a first drive system 102 that is located above the furnace 408 and is configured to drive a main shaft 104 that is either in a geared or belted communication with planetary shafts 106A, 106B, . . . , and so on. The FIG. 1 depicts a geared rotary communication between the main shaft 104 and planetary shafts 106A, 106B, . . . , and so on. Each planetary shaft 106A, 106B, . . . , and so on, is in contact with pull rods 113A, 113B, . . . , and so on respectively. Each of the pull rods 113A, 113B, . . . , and so on, have a seed crystal (not shown) disposed at an end that is opposed to the end that contacts the planetary shafts. This seed crystal is dipped into the molten raw material present in the respective crucibles 114A, 114B, . . . , and so on, and slowly extracted. The melt grows on the seed crystal in a crystalline fashion. As the seed is extracted, the melt solidifies and eventually a large, cylindrical crystal boule is produced. A crystal boule is a single-crystal ingot produced by using a seed crystal to create a larger crystal, or ingot. In an embodiment, the diameter of each crystal boule is typically less than half the diameter of the crucible from which the boule is manufactured.

In an embodiment, each pull rod 113A, 113B, . . . , having a seed crystal disposed at its lower end is dipped into the respective melts 122A and 122B and then slowly moved away from the melt (moved vertically) while undergoing rotary motion.

The rotary motion either clockwise or counterclockwise is used to control the interface shape of the boule while it is in the melt. A translation motion is used to control the pull rate of the boule by extracting the boule from the melt under a controlled translation rate. The translational motion refers to the linear movement of the pull rod (or boule) either upward or downward, which controls the rate at which the boule is extracted from the melt. This means that the pull rod moves vertically in a straight line to pull each respective crystal boule 122A, 122B, . . . , and so on, out of the melt at a controlled speed. translation motion is used to control the pull rate of the boule by extracting the boule from the melt under a controlled translation rate. The translational motion refers to the linear movement of the pull rod (or boule) either upward or downward, which controls the rate at which the boule is extracted from the melt. This means that the pull rod moves vertically in a straight line to pull the respective crystal boules 122A, 122B, . . . , and so on, out of the melt at a controlled speed.

With reference now again to the first drive 102 it is to be noted that the drive may facilitate rotation of each of the primary shafts 106A, 106B, and so on, while also facilitating translational motion of each of the primary shafts. The shafts 106A, 106, and so on, may be coupled or decoupled from the main shaft 104. In the FIG. 1, in an exemplary embodiment, the main shaft 104 functions as the sun gear and transfers it motion to one or more planetary gears 112A, 112B, and so on. The planetary gears in turn transmit motion to the first planetary shafts 106A, 106B, and so on, respectively.

Located on the bottom of the furnace is a second drive 202. The secondary drive 202 also contains a second main shaft 204, which is in rotary and/or vertical translational motion with a plurality of second planetary shafts 211A, 211B, and so on. The second planetary shafts 211A, 211B, and so on, are in communication with a plurality of stages 213A, 213B, and so on. The plurality of stages 213A, 213B, and so on, may rotate at a rate slower than the rotation rate of the shafts 113A and 113B. In an embodiment, the stages may be rotated in the same direction as that of shafts 113A and 113B or may be rotated in a direction opposite to that of shafts 113A and 113B.

The second drive 202 comprises a second main shaft 204 which is in rotary communication with a plurality of second planetary shafts 211A and 211B via a geared or belt drive. The second main shaft 204 is in rotary communication with a motor (not shown) which drives the second main shaft. The second main shaft 204 is in contact with the motor through a clutch (not shown) that may be used to engage or disengage the second main shaft 204 from the motor. In an embodiment, the secondary drive is operative to be decoupled from each stage of the plurality of stages. In an embodiment, depicted in the FIG. 1, a second main gear 210 fixedly attached to the second main shaft 204 is in rotary communication with second planetary shafts 211A and 211B.

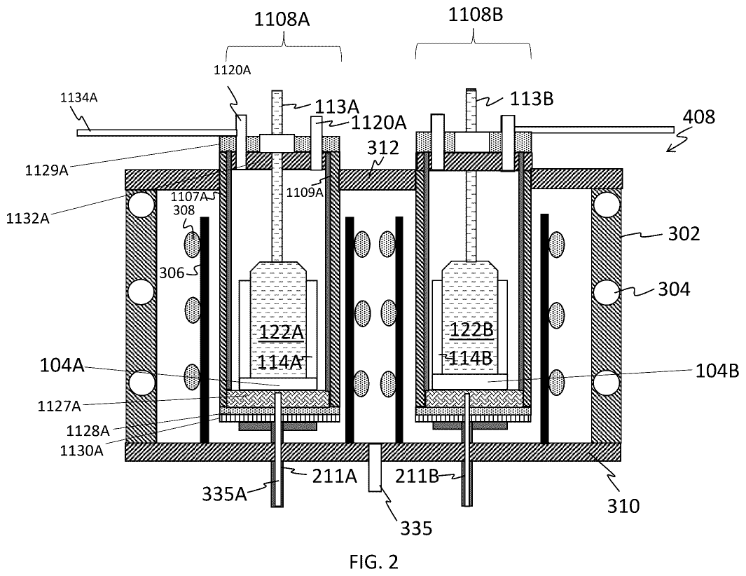

FIG. 2 is an exemplary detailed depiction of the furnace 408 from the FIG. 1. The furnace 408 comprises walls 302 in which cooling tubes 304 are located.

Alternatively, the cooling coils may be located outside the walls of the furnace (not shown). Fluid flowing through the cooling tubes 304 can be used to extract heat from the furnace. The furnace wall 302 is mounted on a base surface 310 and has a furnace cover 312 disposed on an end (of the furnace wall 302) opposite the base surface 310. The base surface 310 may contain channels that can be used to locate induction coils (not shown), coils for carrying a cooling fluids (not shown) or components that can facilitate mechanical movement (not shown). Disposed in the furnace 408 is a growth chamber 306 in which are disposed the crucibles 114A and 114B.

Noble metals and suitable alloys of noble metals may be used to manufacture the crucibles 114A and 114B. The respective crucibles are typically manufactured from a noble metal such as ruthenium (Ru), rhodium (Rh), palladium (Pd), silver (Ag), osmium (Os), iridium (Ir), platinum (Pt), gold (Ag), or a combination thereof. Iridium is commonly used in crucibles that are used to manufacture scintillator single crystals or other high temperature materials that are not oxides or are not used for scintillation.

As noted above, each furnace 408 may comprise a plurality of crucibles 114A, 114B, . . . , and so on, that may be used to simultaneously produce a plurality of crystalline boules 122A, 122B, . . . , and so on. Each of the plurality of crucibles 114A, 114B, . . . , and so on, are contained in a growth chamber 1108A, 1108B, . . . , and so on. For purposes of simplicity, only one of the plurality of growth chambers 1108A will be described in detail.

The growth chamber 1108A contains an outer tube 1107A, an inner tube 1109A, a growth chamber bottom plate 1128A and a growth chamber outer top plate 1129A. The outer tube 1107A and inner tube 1109A are disposed between the growth chamber bottom plate 1128A and the growth chamber outer top plate 1129A. The growth chamber outer top plate 1129A may be disposed on a growth chamber inner top plate 1132A. The growth chamber inner top plate 1132A contacts the upper portion of the outer tube 1107A. The outer tube 1107A is typically manufactured from quartz, while the inner tube 1109A is typically manufactured from zirconia. A first O-ring seal (not shown) may be disposed between the outer tube 1107A and the growth chamber bottom plate 1128A. A second O-ring (not shown) is disposed between the outer tube 1107A and the growth chamber inner top plate 1132A. Disposed between the growth chamber bottom plate 1128A and the crucible 114A is a bed of grog 1127A. In an embodiment, the first bed of grog 1127A contacts the bottom of the crucible 114A. Grog is a material often used in furnaces for its heat-resistant properties. It is typically made from crushed, fired clay or other refractory materials. When mixed with other substances like clay or cement, grog can improve the overall strength, thermal shock resistance, and insulation properties of refractory materials used in furnaces, kilns, and other high-temperature applications. In an embodiment, the bed of grog 1127A comprises beds of zirconia, alumina, or a combination thereof.

Disposed beneath the growth chamber bottom plate 1128A and the base surface 104A of the furnace is a porous frit 1130A that comprises granules or briquettes of a heat resistant material. The porous frit 1130A can also permit an inert gas to pass through it.

The upper plate 1129A contains one or more inlet ports 1134A (that contact two eyepieces 1120A) through which a second growth gas stream may be introduced to surround the crystal boule and the melt in the crucible 114A. The second growth gas stream may be the same as the first growth gas stream (which is described above). The eyepieces 1120A may contain lenses (not shown) through which the activity in the growth chamber 1108A may be viewed.

Disposed between the furnace 302 and the growth chamber 1108A are induction coils 308. The induction coils 308 (also referred to as radio-frequency (RF) coils) are used to heat the crucible and its contents and to produce the melt from which the crystal boule is manufactured. The growth chamber 1108A can be moved vertically (up and down) or kept stationary with respect to the induction coils 308.

Disposed in the base surface 310 is a conduit 335A that functions as an inlet for a first growth gas stream. The growth atmosphere (formed by the first growth gas stream) is crystal composition and crucible composition dependent. The growth atmosphere may be reducing when containing hydrogen gas, slightly reducing when containing nitrogen gas, oxidizing when containing air, CO₂, nitrogen mixed with air or oxygen, or any noble gas mixed with air or O₂. The growth chamber 108 protrudes through an opening in the furnace cover 312. The furnace cover 312 may contain internal cooling coils (not shown) through which a cooling fluid is discharged. The crucible 114A contains a melt 122A that is obtained from melting raw materials. A pull rod 113A having a seed crystal (not shown) disposed at its lower end is dipped into the melt 122A and then slowly moved away from the melt (moved vertically) while undergoing rotary motion. The rotary motion either clockwise or counterclockwise is used to control the interface shape of the boule while it is in the melt. The translation motion is used to control the pull rate of the boule by extracting the boule from the melt under a controlled translation rate. The translational motion refers to the linear movement of the pull rod (or boule) either upward or downward, which controls the rate at which the boule is extracted from the melt. This means that the pull rod moves vertically in a straight line to pull the crystal boule out of the melt at a controlled speed.

A crystal boule is a single-crystal ingot produced by using a seed crystal to create a larger crystal, or ingot. This seed crystal is dipped into the molten raw material and slowly extracted. The melt grows on the seed crystal in a crystalline fashion. As the seed is extracted, the melt solidifies and eventually a large, cylindrical crystal boule is produced.

The furnace described herein is advantageous in that it contains a plurality of crucibles that may be used to simultaneously produce a plurality of crystalline boules. At least 2 through 6 crystalline boules may be produced or be in production at any given time in the furnace.

In an embodiment, each crucible of the plurality of crucibles may contain a different raw material composition. In another embodiment, at least two crucibles of the plurality of crucibles contain a raw material composition that is different from one another. In an embodiment, batches or crystalline boules of identical compositions or of different compositions may be manufactured simultaneously. For example, a first batch of crystalline boules having a first composition may be manufactured simultaneously or sequentially with a second batch of crystalline boules having a second composition. The first composition is different from the second composition.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A furnace for producing a plurality of single crystal boules, the furnace comprising:
a furnace wall;
a plurality of crucibles, where each crucible is operative to contain a melt that is contacted by a different pull rod; where each pull rod is attached to seed a crystal;
a first drive system that is located above the furnace and is configured to drive a first main shaft that is either in a geared or belted communication with a plurality of first planetary shafts; where each pull rod is in rotary communication at least one planetary shaft; where each pull rod is operative to simultaneously contact the melt in one of the plurality of crucibles while undergoing rotary and translational motion with respect to the melt in a respective crucible;
where each crucible is surrounded by an induction coil and a refractory lining; and
wherein each induction coil and refractory lining lie within the furnace wall.

2. The furnace of claim 1, wherein the main shaft is in geared communication with each planetary shaft.

3. The furnace of claim 1, where each planetary shaft is operative to be coupled or decoupled from the main shaft.

4. The furnace of claim 1, wherein the furnace further comprises a secondary drive system located below the furnace.

5. The furnace of claim 4, wherein the secondary drive comprises a second main shaft which is in rotary and/or vertical translational motion with a plurality of second planetary shafts.

6. The furnace of claim 5, wherein the second planetary shafts are further in respective communication with a plurality of stages; where each stage is in communication with a crucible of the plurality of crucibles.

7. The furnace of claim 6, wherein each secondary planetary shaft is operative to rotate in a same direction as each first planetary shaft.

8. The furnace of claim 7, where each secondary planetary shaft is operative to rotate at a slower rate than each first planetary shaft.

9. The furnace of claim 6, wherein each secondary planetary shaft is operative to rotate in an opposite direction as each first planetary shaft.

10. The furnace of claim 6, wherein the secondary drive is operative to be decoupled from each stage of the plurality of stages.

11. The furnace of claim 6, wherein the furnace walls comprise cooling tubes that transport a cooling fluid.

12. A method for simultaneously producing a plurality of crystalline boules, the method comprising:
disposing raw materials in each crucible of a plurality of crucibles, where each crucible is located within a wall of a furnace;
heating the raw materials to a melt point;
contacting each melt in each crucible with a pull rod; where each pull rod is in rotary and translational communication with a first drive system that is located above the furnace;
where the first drive system is configured to drive a first main shaft that is either in a geared or belted communication with a plurality of first planetary shafts; where each pull rod is in rotary communication at least one planetary shaft; where each pull rod is operative to contact the melt while undergoing rotary and translational motion with respect to a melt in each one of the plurality of crucibles.

13. The method of claim 12, further comprising rotating each crucible via a secondary drive system located below the furnace; wherein the secondary drive comprises a second main shaft which is in rotary and/or vertical translational motion with a plurality of second planetary shafts.

14. The method of claim 13, further comprising contacting each stage of the plurality of stages with a second planetary shafts; where each stage is in communication with a crucible of the plurality of crucibles.

15. The method of claim 14, wherein each secondary planetary shaft is operative to rotate in a same direction as each first planetary shaft.

16. The method of claim 15, where each secondary planetary shaft is operative to rotate at a slower rate than each first planetary shaft.

17. The method of claim 16, wherein each secondary planetary shaft is operative to rotate in an opposite direction as each first planetary shaft.

18. The method of claim 12, where each crucible of the plurality of crucibles contain a different raw material composition.

19. The method of claim 12, where at least two crucibles of the plurality of crucibles contain a raw material composition that is different from one another.
